(19) United States
(12) Patent Application Publication
(10) Pub. No.: US 2015/0205755 A1
(43) Pub. Date: Jul. 23, 2015

(54) Extensible Media Format System and Methods of Use

(71) Applicant: RISOFTDEV, Inc., Moraga, CA (US)

(72) Inventor: Vincent Logan Gilbert, Yachats, OR (US)

(73) Assignee: RISOFTDEV, INC., Moraga, CA (US)

(21) Appl. No.: 14/450,091

(22) Filed: Aug. 1, 2014

Related U.S. Application Data
(60) Provisional application No. 61/862,290, filed on Aug. 5, 2013.

(51) Int. Cl. G06F 15/167; H04L 29/06; H04L 29/08

(52) U.S. Cl. CPC G06F 15/167; H04L 67/06; H04L 63/062

(57) ABSTRACT

A system and associated methods for managing digital content in an extensible media format (“EMF”) are disclosed. In at least one embodiment, an initial request server is located in memory on a computing device and configured for receiving and processing content requests from an at least one client device in the possession of a user. A content server is also located in memory on a computing device and is configured for storing and selectively distributing the content. The content server stores the content in an at least one EMF file, each EMF file comprising a frame page containing a frame page identifier and an at least one frame; each frame containing at least a portion of the content along with a frame identifier. Upon the initial request server receiving a content request from the user via the associated client device, the content server transmits the associated EMF files.

### RELATED APPLICATIONS

This application claims priority and is entitled to the filing date of U.S. provisional application Ser. No. 61/862,290, filed on Aug. 5, 2013 and entitled “Extensible Media Format System and Method of Use.” The contents of the aforementioned application are incorporated by reference herein.

### BACKGROUND

The subject of this patent application relates generally to content delivery systems, and more particularly to an improved system and methods for encoding, storing, retrieving and delivering digital content using Extensible Markup Language (“XML”).

Applicant(s) hereby incorporate herein by reference any and all patents and published patent applications cited or referred to in this application.

By way of background, content delivery involves the delivery or distribution of media content—such as audio, video, software, video games, books, documents, etc.—usually over an online delivery medium, such as the Internet, without the use of physical media. Content distributed online may be streamed or downloaded. Streaming involves downloading and using content at a user's request—or “on demand”—rather than allowing a user to store it permanently. By contract, fully downloading content to a hard drive or other form of electronic storage media may allow offline access in the future. Specialist networks known as “content delivery networks” help distribute content over the Internet and attempt to provide both high availability and high performance. However, content is becoming increasingly large. For example, video content (i.e., movies, television shows, video games, etc.) continues to be produced in higher and higher resolutions, and at faster frame rates, which results in relatively larger content files that becoming increasingly difficult (or at least time- and bandwidth-consuming) to distribute over the Internet. As such, there remains a need for a relatively fast, reliable way to distribute content over the Internet, regardless of the size of that content. There also remains a need for such a system that is capable of better preventing such content from being copied without permission, or from being viewed by users who should not have access to the content.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a system and associated methods for managing digital content in an extensible media format (“EMF”). In at least one embodiment, an at least one initial request server is located in memory on an at least one computing device and configured for receiving and processing requests for content from an at least one client device in the possession of a user. An at least one content server is also located in memory on the at least one computing device and is configured for storing and selectively distributing the content. The content server stores the content in an at least one EMF file, each EMF file comprising a frame page containing a frame page identifier, used for sequentially arranging the at least one EMF file when assembling the content on the client device, and an at least one frame; each frame containing at least a portion of the content along with a frame identifier used for sequentially arranging the at least one frame when assembling the content on the client device. Thus, upon the initial request server receiving a content request from the user via the associated client device, the content server transmits to said client device each EMF file containing at least a portion of the requested content.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a schematic view of an exemplary extensible media format system, in accordance with at least one embodiment;

FIG. 2 is a block diagram illustrating an exemplary token data structure, in accordance with at least one embodiment;

FIG. 3 a flow diagram of an exemplary method for encoding, storing, retrieving and delivering digital content, in accordance with at least one embodiment;

FIG. 4 is a block diagram illustrating an exemplary extensible media format file structure, in accordance with at least one embodiment;

FIG. 5 is a flow diagram of an exemplary method for compressing an exemplary extensible media format file, in accordance with at least one embodiment;

FIG. 6 is a flow diagram of an exemplary method for compressing an exemplary frame page, in accordance with at least one embodiment; and

FIG. 7 is an illustration of an exemplary frame page as processed by an exemplary frame page compression algorithm, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

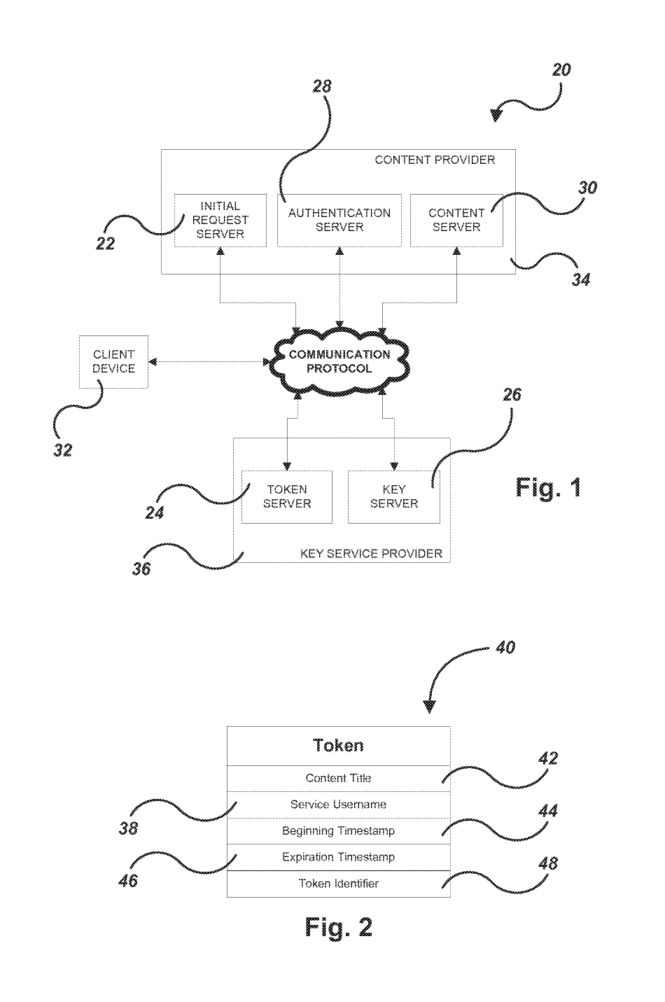

Turning now to FIG. 1, there is shown a schematic view of an exemplary embodiment of an exemplary extensible media format (“EMF”) system 20 configured for encoding, storing, retrieving and delivering—or, in other words, managing—digital content using Extensible Markup Language (“XML”). At the outset, it should be noted that while the system 20 is discussed primarily in terms of XML in the exemplary embodiment, in further embodiments, any other digital communication or delivery protocol now known or later developed may be substituted, so long as the system 20 is capable of substantially carrying out the functionality described herein. As discussed further below, the extensibility of the EMF format allows the system 20 to process and handle virtually any type of digital content (hereinafter referred to simply as “content”); though, the most common types of content are video-based and audio-based.

The system 20 comprises, in the exemplary embodiment, an at least one initial request server 22, an at least one token server 24, an at least one key server 26, an at least one authentication server 28, and an at least one content server 30, each residing in memory on an at least one computing device. It should be noted that the term “memory” is intended to include any type of electronic storage medium (or combination of storage mediums) now known or later developed, such as local hard drives, RAM, flash memory, external storage devices, network or cloud storage devices, etc. Furthermore, the various components of the system 20 may reside in memory on a single computing device, or may separately reside on two or more computing devices in communication with one another. Additionally, an at least one client device 32 (itself a computing device), in the possession of a user, is also in selective communication with the system 20. The term “computing device” is intended to include any type of computing device now known or later developed, such as desktop computers, mobile phones, smartphones, laptop computers, tablet computers, personal data assistants, gaming devices, etc.

At the outset, it should also be noted that the means for allowing communication between each of the initial request server 22, token server 24, key server 26, authentication server 28, content server 30, and client device 32 may be any wired- or wireless-based communication protocol (or combination of protocols) now known or later developed. As such, the present invention should not be read as being limited to any one particular type of communication protocol, even though certain exemplary protocols may be mentioned herein for illustrative purposes.

In a bit more detail, in at least one embodiment, each of the initial request server 22, authentication server 28, and content server 30 is maintained by a content provider 34, while each of the key server 26 and token server 24 is maintained by a key service provider 36. In this way, such a key service provider 36 is capable of providing data encryption services to more than one content provider 34. In alternate embodiments, each of the initial request server 22, token server 24, key server 26, authentication server 28, and content server 30 may be maintained by a single entity or multiple entities, so long as the system 20 is substantially able to carry out the functionality herein described.

With continued reference to FIG. 1, in at least one embodiment, the initial request server 22 is configured for receiving and processing requests for content from the at least one client device 32. In light of this, it is again possible, in at least one embodiment, for the content provider 34 to be an entirely separate entity from that of the key service provider 36. As discussed further below, the initial request server 22 is also configured for receiving and processing data related to the user of the client device 32 in order to verify the identity of the user. In the exemplary embodiment, this data includes at least a unique service username 38, a service password, and a content uniform resource identifier (“URI”)—i.e., the URI associated with the content being requested by the client device 32. The authentication server 28 is configured for receiving from the initial request server 22 and authenticating the service username 38 and service password that were provided by the user. The token server 24 is configured for creating and storing unique tokens 40 to be associated with a given user. As shown in FIG. 2, in at least one embodiment, each token 40 includes a content title 42 (i.e., the title of the content being requested by the user), the service username 38, a beginning timestamp 44 (i.e., the time at which the user is authorized to begin accessing the requested content), an expiration timestamp 46 (i.e., the time at which the user is no longer authorized to access the requested content), and a unique token identifier 48. Referring again to FIG. 1, the content server 30 is configured for storing and selectively distributing the content. Finally, the key server 26 is configured for creating and storing a unique key file to be associated with a given user, along with related databases containing information about content providers 34. As discussed further below, the key file is used by the content server 30 to encrypt the content before transmitting it to the client device 32.

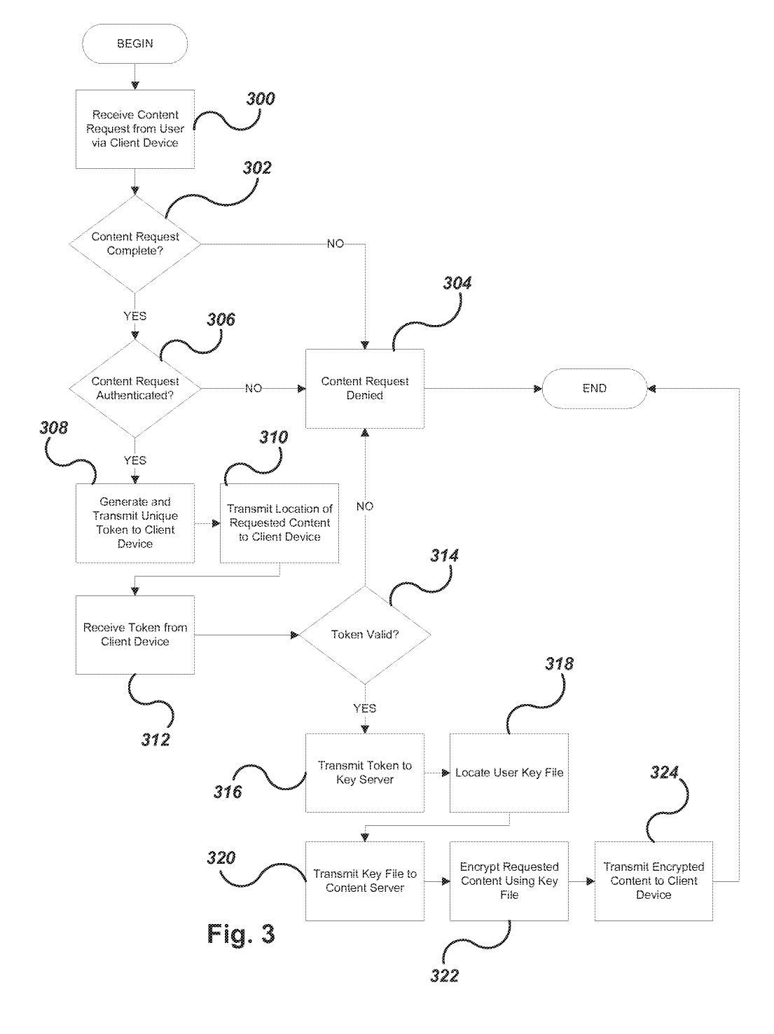

In use then, in at least one embodiment, as illustrated in the flow diagram of FIG. 3, upon the initial request server 22 receiving a content request from the user via the client device 32 (300), the initial request server 22 first determines whether the content request contains the service username 38, service password and content URI (302)—if one or more of those components are absent, the content request is denied (304). Otherwise, the initial request server 22 forwards the content request to the authentication server 28 for validation (306). If the content request fails the authentication process (i.e., if one or more of the service username 38, service password, and content URI are invalid), the content request is denied (304). Otherwise, if authenticated, the initial request server 22 contacts the token server 24 and requests a token 40 related to the content request (308). The token server 24 creates the appropriate token 40 and transmits it to the client device 32 along with the location of the requested content (310). The client device 32 then transmits the token 40 to the content server 30 (312), at which point the content server 30 communicates with the token server 24 in order to validate the presented token 40 (314). In the exemplary embodiment, this validation process includes verifying the token identifier 48 as well as whether the time of validation falls within the window of time defined by the beginning timestamp 44 and expiration timestamp 46 contained in the token 40. If the validation process fails, the content request is denied (304). Otherwise, if the token 40 is found to be valid, the content server 30 transmits the token 40 to the key server 26 (316), at which point the key server 26 locates the unique key file associated with the user (318) based on the service username 38 contained in the token 40 and transmits the key file to the content server 30 (320). The content server 30 then uses the key file to encrypt the requested content (322) and transmits the encrypted content to the client device 32 (324). In at least one embodiment, and as discussed further below, where the content includes visual media (i.e., photo, video, etc.), the content server 30 also uses the key file to overlay a unique watermark onto the content. It should be noted that these steps are merely taken in the exemplary embodiment. In further embodiments, the steps involved in carrying out the exemplary method for distributing requested content may vary or may occur in different sequences.

As mentioned above, in the exemplary embodiment, the system 20 is configured for encoding, storing, retrieving and delivering content using Extensible Markup Language (“XML”). In other words, the content is stored and delivered in a text-based extensible media format, or “EMF” file 50, using XML, which allows for soft encoding of the content—i.e., encoding or re-encoding content on the fly with relative ease. Depending on the size of the content and the context in which the system 20 is utilized, content may be broken into a plurality of EMF files 50. It should also be noted that, where the content comprises video, such content is oftentimes referred to as extensible video format, or “EVF.” Thus, EMF and EVF are intended to be synonymous terms for the purposes of this disclosure.

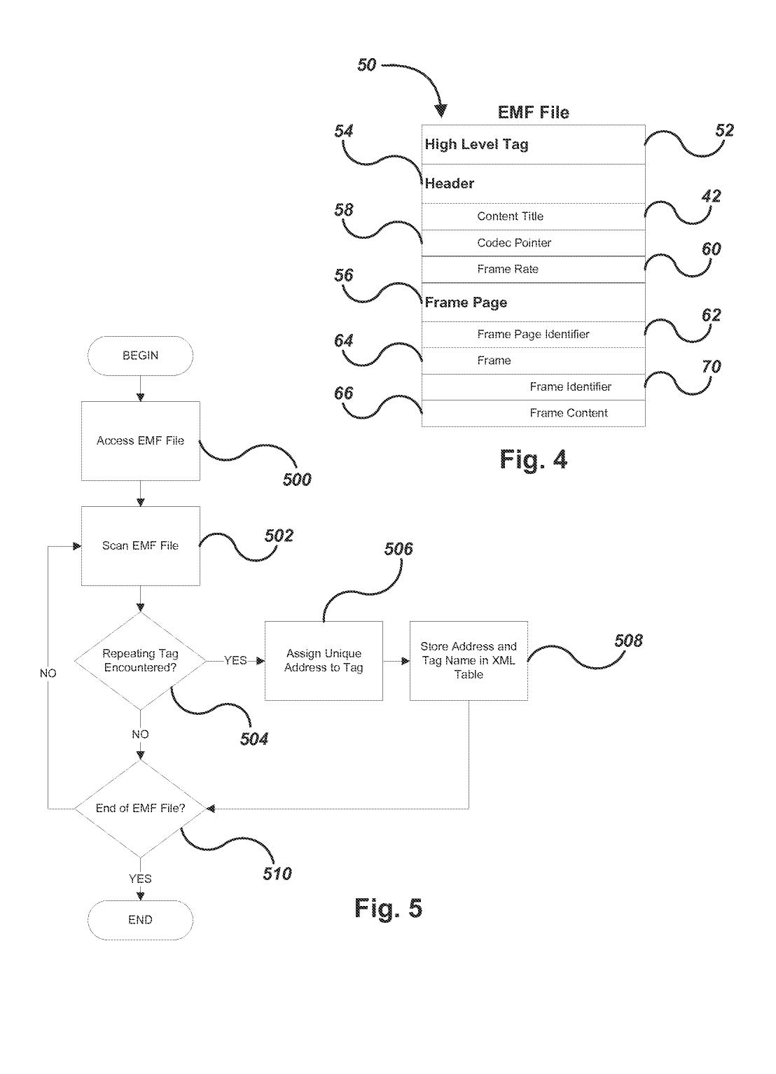

In a bit more detail, in at least one embodiment, and as illustrated in the block diagram of FIG. 4, each EMF file 50 generally comprises a high level tag 52, a header 54, and a frame page 56. The high level tag 52 is configured for indicating the type of content contained in the EMF file 50 (i.e., audio, video, etc.). The header 54 contains select information related to the content contained in the EMF file 50 including but not limited to the content title 42, a pointer 58 to a codec required to access the content, and, where the content contains video, a frame rate 60. In at least one embodiment, the header 54 also contains select user-related data, such as the service username 38, the purpose of which is discussed further below. The frame page 56 contains a frame page identifier 62 and an at least one frame 64 which, in turn, is a data table containing at least a portion of the content 66 represented as bytes 68—though, where the EMF file 50 contains a codec rather than the content itself, the at least one frame 64 contains an XML Schema Definition (“XSD”) and other related codec details. Each frame 64 also includes a frame identifier 70 used for sequentially arranging the frames 64 when assembling the content on the client device 32.

This use of frame pages 56 allows the content (as contained in the EMF files 50) to be delivered through the Internet via a standard web server. In essence, then, in at least one embodiment, the requested content is capable of being stored across one or more frame pages 56 (contained in one or more EMF files 50), dependent on the total size of the requested content, so as to be subsequently transmitted to the client device 32 in a smaller “piecemeal” fashion. As discussed further below, such content may be viewed instantly as soon as a first of the frame pages 56 has been downloaded by the client device 32, rather than having to wait for a greater portion of the content (i.e., a greater number of frame pages 56) to be downloaded so as to form a buffer. This capability is best described as “asynchronous simultaneous downloading.” Additionally, the set of frame pages 56 that comprises a given piece of requested content is able to be stored in any number of locations in a peer-to-peer (“P2P”) format and retrieved and reassembled on the client device 32 as needed, gauging the speed and other delivery parameters of each potential server in real-time so as to obtain each frame page 56 from the fastest determined servers (including, in at least one embodiment, other client devices 32). This can be accomplished, in at least one embodiment, simply based on respective frame page identifiers 62 (which the client device 32 uses to identify and retrieve subsequent frame pages 56 based on subsequent, sequentially ordered frame page identifiers 62), which is much simpler than traditional “bitstream” technology. Thus, if delivery of a desired frame page 56 is too slow due to server side bandwidth or other issues, an alternate location (containing that same desired frame page 56) may be immediately utilized instead. In other words, since this method of delivering the content does not rely on a single data stream, the burden on bandwidth for the delivery of the content is shifted to the client device 32 rather than the content provider 34. This allows the system 20 to deliver video frames (for example) faster and in higher resolution without the need for loss inducing compression algorithms or the like. Therefore, the content may be seamlessly accessed and played by the client device 32 so long as the download rate of the necessary frame pages 56 is faster than the play rate.

In at least one embodiment, the system 20 also employs segmenting, which enables the system 20 to encrypt small portions of an EMF file 50 rather than the entire EMF file 50 at once, where the size of the EMF file 50 would otherwise require significant processing power to encrypt and/or bandwidth to transfer all at once. This also allows the client device 32 to access the EMF file 50 immediately (while portions may still be transmitting and/or decrypting) instead of having to wait for the entire EMF file 50 to be decrypted.

In at least one embodiment, as mentioned above, the system 20 is configured for allowing user-related data to be stored in the header 54 of each EMF file 50 (or EVF file), which can subsequently be used to selectively overlay a unique watermark onto the content, as it is accessed by the client device 32, for identifying purposes. In the exemplary embodiment, the watermark contains the service username 38—however, other types (and quantities) of user-related data may be substituted. Unique positional information associated with the user-related data may also be stored in the header 54, such that the position of the watermark (i.e., a sequence of x,y coordinates) relative to the content is dictated by said positional information. This encoded positional watermarking technique prevents the user from simply blacking the watermark as displayed on the client device 32 to avoid infringement issues, as the sequence of watermark positions would nevertheless be apparent. Since the data associated with requested content is transmitted separately and reassembled by the client device 32, titles and watermarks can be applied in real-time, allowing a piece of video (for example) to contain the service username 38 or any piece of visual data.

In at least one embodiment, due to the architecture of the EMF files 50, the system 20 is capable of applying both encryption and compression algorithms independently to a frame page 56, a group of frame pages 56, or even a single frame 64 within a frame page 56. Additionally, the system 20 is capable of appending instructions for the client device 32 to know how to properly decrypt and/or decompress the object, thereby allowing different encryption and/or compression algorithms to be applied in the most efficient manner possible.

One such compression algorithm utilized by the system 20, in at least one embodiment, is a tag compression algorithm designed to reduce the size of a given EMF file 50. In a bit more detail, and as illustrated in the flow diagram of FIG. 5, the algorithm performs an XML compression in XML format. Specifically, the algorithm consists of the steps of accessing an XML-based file such as a given EMF file 50 (500), scanning the EMF file 50 (502) to determine whether there are any repeating XML tags (i.e., tags that appear more than once) within the EMF file 50 (504), indexing any such repeating XML tags by assigning a unique address to each repeating XML tag (506), and storing the address and associated tag name in an XML table (508). This algorithm continues until the end of the EMF file 50 is reached (510). To subsequently decompress the EMF file 50, the data stored in the XML table is used to re-create (i.e., expand) the repeating portions. It should be noted that this same algorithm is performed, in at least one embodiment, on repeating data within a given EMF file 50 as well—thereby providing for further compression of the EMF file 50.

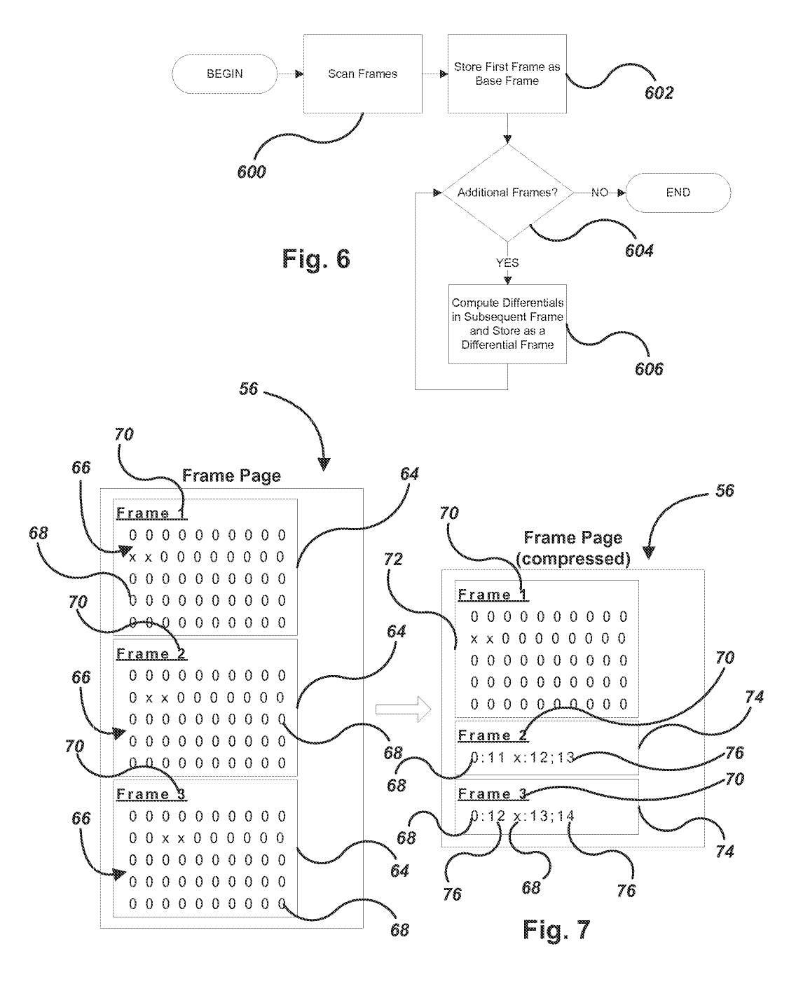

Another type of compression algorithm that is utilized by the system 20, in at least one embodiment, is a frame page compression algorithm designed to reduce the size of a given frame page 56. In a bit more detail, and as illustrated in the flow diagram of FIG. 6 and associated illustration of FIG. 7, the frame page compression algorithm functions as a differential algorithm in that it first scans each of the frames 64 in a given frame page 56 (600), each of the frames 64 comprising the plurality of byte values 68. The first frame 64 of the frame page 56 is stored as a base frame 72 (602) and its byte values 68 are used for computing the differentials (i.e., changes) between the base frame 72 and any subsequent frames 64 in the frame page 56. If there are in fact additional frames 64 in the frame page 56 (604), each subsequent frame 64 is stored as a differential frame 74 (606), basically comprising only the differing byte values 68 for the frame 64 as compared to the base frame 72. In the exemplary embodiment, as illustrated in FIG. 7, these differing byte values 68 are stored in the format, A:X;Y, where A is the byte value 68 and X and Y (along with any additional values separated by semi-colons) are the respective byte positions 76 of that byte value 68 in the frame 64. In an alternate embodiment, each differential frame 74 is computed based on the preceding differential frame 74 (rather than the base frame 72). Thus, rather than transmitting all of the byte values 68 in each of the frames 64 of the frame page 56, only the byte values 68 which have changed from the base frame 72 (or, alternatively, the preceding differential frame 74) are transmitted. Furthermore, because both the byte value 68 and respective byte positions 76 of each differing byte value 68 are stored in the differential frames 74, the entire frames 64 are easily reconstructed after transmission.

Aspects of the present specification may also be described as follows:

1. A computer-implemented method for managing digital content in an extensible media format, the method comprising the steps of: implementing an at least one initial request server in memory on an at least one computing device, said initial request server configured for receiving and processing requests for content from an at least one client device in the possession of a user; implementing an at least one content server in memory on the at least one computing device, said content server configured for storing and selectively distributing the content; storing the content in an at least one text-based extensible media format (“EMF”) file, each EMF file comprising a frame page containing a frame page identifier, used for sequentially arranging the at least one EMF file when assembling the content on the client device, and an at least one frame, each frame containing at least a portion of the content along with a frame identifier used for sequentially arranging the at least one frame when assembling the content on the client device; and upon the initial request server receiving a content request from the user via the associated client device, transmitting to said client device each EMF file containing at least a portion of the requested content.

2. The method according to embodiment 1, further comprising the steps of: implementing an at least one authentication server in memory on the at least one computing device, said authentication server configured for authenticating the identity of the user; implementing an at least one token server in memory on the at least one computing device, said token server configured for creating and storing an at least one unique token to be associated with the user; and implementing an at least one key server in memory on the at least one computing device, said key server configured for creating and storing a unique key file to be associated with the user.

3. The method according to embodiments 1-2, wherein the step of transmitting to said client device each EMF file containing at least a portion of the requested content further comprises the steps of: determining whether the content request contains each of a username and a password associated with said user, along with a content uniform resource identifier (“URI”) associated with the requested content; upon determining that at least one of the username, password and content URI is absent in the content request, denying said content request; validating each of the service username, service password and content URI contained in the content request; upon unsuccessfully validating the content request, denying said content request; and upon successfully validating the content request, transmitting to said client device each EMF file containing at least a portion of the requested content.

4. The method according to embodiments 1-3, wherein the step of transmitting to said client device each EMF file containing at least a portion of the requested content further comprises the steps of: creating a unique token containing at least one of a title of the requested content, a username associated with said user, a beginning timestamp which defines a beginning time at which said user is authorized to receive the requested content, an expiration timestamp which defines an ending time beyond which said user is no longer authorized to receive the requested content, and a unique token identifier; transmitting the token to said client device along with a location of the requested content, said token to be subsequently provided by said client device to the content server; and upon receiving the token from said client device: validating the token; upon unsuccessfully validating the token, denying said content request; and upon successfully validating the token, transmitting to said client device each EMF file containing at least a portion of the requested content.

5. The method according to embodiments 1-4, wherein the step of validating the token further comprises the steps of: verifying the token identifier; and determining whether said user is currently authorized to receive the requested content based on the beginning timestamp and expiration timestamp contained in the token.

6. The method according to embodiments 1-5, wherein the step of transmitting to said client device each EMF file containing at least a portion of the requested content further comprises the steps of: obtaining from the key server the key file associated with said user; separately encrypting at least one of the at least one EMF file containing the requested content using said key file; and transmitting each of the at least one encrypted EMF file to said client device.

7. The method according to embodiments 1-6, further comprising the step of implementing an at least one content provider in memory on the at least one computing device, said content provider configured for maintaining each of the initial request server, authentication server, and content server.

8. The method according to embodiments 1-7, further comprising the step of implementing a key service provider in memory on the at least one computing device, said key service provider configured for maintaining each of the key server and token server.

9. The method according to embodiments 1-8, further comprising the steps of: selectively dividing the content into a plurality of EMF files, dependent on the total size of the content; and transmitting the content, when requested by the user, to the associated client device one EMF file at a time.

10. The method according to embodiments 1-9, further comprising the steps of: storing each of the plurality of EMF files across multiple client devices in a peer-to-peer network; and selectively retrieving each of the plurality of EMF files from said client devices based on the availability of said client devices.

11. The method according to embodiments 1-10, further comprising the step of compressing at least one of the plurality of EMF files containing the requested content.

12. The method according to embodiments 1-11, wherein the step of compressing at least one of the plurality of EMF files further comprises the steps of, for each such EMF file: determining whether the EMF file contains any XML tags that appear more than once within the EMF file; and for each XML tag determined to appear more than once within the EMF file: assigning a unique address to the XML tag; and storing the address and associated XML tag in an XML table, said XML table used for subsequently decompressing the EMF file.

13. The method according to embodiments 1-12, wherein the step of compressing at least one of the plurality of EMF files further comprises the steps of, for each such EMF file: determining whether the EMF file contains any data that appears more than once within the EMF file; and for any data determined to appear more than once within the EMF file: assigning a unique address to the data; and storing the address and associated data in an XML table, said XML table used for subsequently decompressing the EMF file.

14. The method according to embodiments 1-13, wherein the step of compressing at least one of the plurality of EMF files further comprises the steps of, for each such EMF file: scanning each of the at least one frame stored in the associated frame page, the at least one frame containing a plurality of byte values representing at least a portion of the content; storing a first one of said frames as a base frame; and for each additional frame stored in the associated frame page: computing any differentials between the byte values contained in the base frame and the byte values contained in said additional frame; and storing said additional frame as a differential frame comprising only the differing byte values contained in said additional frame as compared to the base frame.

15. The method according to embodiments 1-14, wherein the step of compressing at least one of the plurality of EMF files further comprises the steps of, for each such EMF file: scanning each of the at least one frame stored in the associated frame page, the at least one frame containing a plurality of byte values representing at least a portion of the content; storing a first one of said frames as a base frame; and for each subsequent frame stored in the associated frame page: computing any differentials between the byte values contained in a preceding frame and the byte values contained in said subsequent frame; and storing said subsequent frame as a differential frame comprising only the differing byte values contained in said subsequent frame as compared to the preceding frame.

16. The method according to embodiments 1-15, further comprising the step of selectively overlaying a unique user-specific watermark onto the content, prior to said content being transmitted to the associated client device, for identifying purposes.

17. The method according to embodiments 1-16, wherein the step of selectively overlaying the unique watermark onto the content further comprises the step of positioning the watermark, relative to the content, based on select user-specific positional information.

18. A computer-implemented method for managing digital content in an extensible media format, the method comprising the steps of: implementing an at least one initial request server in memory on an at least one computing device, said initial request server configured for receiving and processing requests for content from an at least one client device in the possession of a user; implementing an at least one content server in memory on the at least one computing device, said content server configured for storing and selectively distributing the content; implementing an at least one key server in memory on the at least one computing device, said key server configured for creating and storing a unique key file to be associated with the user; storing the content in an at least one text-based extensible media format (“EMF”) file, each EMF file comprising a frame page containing a frame page identifier, used for sequentially arranging the at least one EMF file when assembling the content on the client device, and an at least one frame, each frame containing at least a portion of the content along with a frame identifier used for sequentially arranging the at least one frame when assembling the content on the client device; and upon the initial request server receiving a content request from the user via the associated client device: obtaining from the key server the key file associated with said user; separately encrypting at least one of the at least one EMF file containing the requested content using said key file; and transmitting each of the at least one encrypted EMF file to said client device.

19. A computer-implemented method for managing digital content in an extensible media format, the method comprising the steps of: implementing an at least one initial request server in memory on an at least one computing device, said initial request server configured for receiving and processing requests for content from an at least one client device in the possession of a user; implementing an at least one content server in memory on the at least one computing device, said content server configured for storing and selectively distributing the content; storing the content in an at least one text-based extensible media format (“EMF”) file, each EMF file comprising a frame page containing a frame page identifier, used for sequentially arranging the at least one EMF file when assembling the content on the client device, and an at least one frame, each frame containing at least a portion of the content along with a frame identifier used for sequentially arranging the at least one frame when assembling the content on the client device; separately compressing at least one of the at least one EMF file containing the content; and upon the initial request server receiving a content request from the user via the associated client device, transmitting to said client device each of the at least one compressed EMF file containing at least a portion of the requested content.

Regarding the exemplary embodiments of the present invention as shown and described herein, it will be appreciated that an extensible media format system is disclosed and configured for encoding, storing, retrieving and delivering digital content using Extensible Markup Language (“XML”). Because the principles of the invention may be practiced in a number of configurations beyond those shown and described, it is to be understood that the invention is not in any way limited by the exemplary embodiments, but is generally directed to an extensible media format system and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A computer-implemented method for managing digital content in an extensible media format, the method comprising the steps of:
implementing an at least one initial request server in memory on an at least one computing device, said initial request server configured for receiving and processing requests for content from an at least one client device in the possession of a user;
implementing an at least one content server in memory on the at least one computing device, said content server configured for storing and selectively distributing the content;
storing the content in an at least one text-based extensible media format (“EMF”) file, each EMF file comprising a frame page containing a frame page identifier, used for sequentially arranging the at least one EMF file when assembling the content on the client device, and an at least one frame, each frame containing at least a portion of the content along with a frame identifier used for sequentially arranging the at least one frame when assembling the content on the client device; and
upon the initial request server receiving a content request from the user via the associated client device, transmitting to said client device each EMF file containing at least a portion of the requested content.

2. The method of claim 1, further comprising the steps of:
implementing an at least one authentication server in memory on the at least one computing device, said authentication server configured for authenticating the identity of the user;
implementing an at least one token server in memory on the at least one computing device, said token server configured for creating and storing an at least one unique token to be associated with the user; and
implementing an at least one key server in memory on the at least one computing device, said key server configured for creating and storing a unique key file to be associated with the user.

3. The method of claim 2, wherein the step of transmitting to said client device each EMF file containing at least a portion of the requested content further comprises the steps of:
determining whether the content request contains each of a username and a password associated with said user, along with a content uniform resource identifier (“URI”) associated with the requested content;
upon determining that at least one of the username, password and content URI is absent in the content request, denying said content request;
validating each of the service username, service password and content URI contained in the content request;
upon unsuccessfully validating the content request, denying said content request; and
upon successfully validating the content request, transmitting to said client device each EMF file containing at least a portion of the requested content.

4. The method of claim 2, wherein the step of transmitting to said client device each EMF file containing at least a portion of the requested content further comprises the steps of:
creating a unique token containing at least one of a title of the requested content, a username associated with said user, a beginning timestamp which defines a beginning time at which said user is authorized to receive the requested content, an expiration timestamp which defines an ending time beyond which said user is no longer authorized to receive the requested content, and a unique token identifier;
transmitting the token to said client device along with a location of the requested content, said token to be subsequently provided by said client device to the content server; and
upon receiving the token from said client device:
validating the token;
upon unsuccessfully validating the token, denying said content request; and
upon successfully validating the token, transmitting to said client device each EMF file containing at least a portion of the requested content.

5. The method of claim 4, wherein the step of validating the token further comprises the steps of:
verifying the token identifier; and
determining whether said user is currently authorized to receive the requested content based on the beginning timestamp and expiration timestamp contained in the token.

6. The method of claim 2, wherein the step of transmitting to said client device each EMF file containing at least a portion of the requested content further comprises the steps of:
obtaining from the key server the key file associated with said user;
separately encrypting at least one of the at least one EMF file containing the requested content using said key file; and
transmitting each of the at least one encrypted EMF file to said client device.

7. The method of claim 2, further comprising the step of implementing an at least one content provider in memory on the at least one computing device, said content provider configured for maintaining each of the initial request server, authentication server, and content server.

8. The method of claim 2, further comprising the step of implementing a key service provider in memory on the at least one computing device, said key service provider configured for maintaining each of the key server and token server.

9. The method of claim 1, further comprising the steps of:
selectively dividing the content into a plurality of EMF files, dependent on the total size of the content; and
transmitting the content, when requested by the user, to the associated client device one EMF file at a time.

10. The method of claim 9, further comprising the steps of:
storing each of the plurality of EMF files across multiple client devices in a peer-to-peer network; and
selectively retrieving each of the plurality of EMF files from said client devices based on the availability of said client devices.

11. The method of claim 9, further comprising the step of compressing at least one of the plurality of EMF files containing the requested content.

12. The method of claim 11, wherein the step of compressing at least one of the plurality of EMF files further comprises the steps of, for each such EMF file:
determining whether the EMF file contains any XML tags that appear more than once within the EMF file; and
for each XML tag determined to appear more than once within the EMF file:
assigning a unique address to the XML tag; and
storing the address and associated XML tag in an XML table, said XML table used for subsequently decompressing the EMF file.

13. The method of claim 11, wherein the step of compressing at least one of the plurality of EMF files further comprises the steps of, for each such EMF file:
determining whether the EMF file contains any data that appears more than once within the EMF file; and
for any data determined to appear more than once within the EMF file:
assigning a unique address to the data; and
storing the address and associated data in an XML table, said XML table used for subsequently decompressing the EMF file.

14. The method of claim 11, wherein the step of compressing at least one of the plurality of EMF files further comprises the steps of, for each such EMF file:
scanning each of the at least one frame stored in the associated frame page, the at least one frame containing a plurality of byte values representing at least a portion of the content;
storing a first one of said frames as a base frame; and
for each additional frame stored in the associated frame page:
computing any differentials between the byte values contained in the base frame and the byte values contained in said additional frame; and
storing said additional frame as a differential frame comprising only the differing byte values contained in said additional frame as compared to the base frame.

15. The method of claim 11, wherein the step of compressing at least one of the plurality of EMF files further comprises the steps of, for each such EMF file:
scanning each of the at least one frame stored in the associated frame page, the at least one frame containing a plurality of byte values representing at least a portion of the content;
storing a first one of said frames as a base frame; and
for each subsequent frame stored in the associated frame page:
computing any differentials between the byte values contained in a preceding frame and the byte values contained in said subsequent frame; and
storing said subsequent frame as a differential frame comprising only the differing byte values contained in said subsequent frame as compared to the preceding frame.

16. The method of claim 1, further comprising the step of selectively overlaying a unique user-specific watermark onto the content, prior to said content being transmitted to the associated client device, for identifying purposes.

17. The method of claim 16, wherein the step of selectively overlaying the unique watermark onto the content further comprises the step of positioning the watermark, relative to the content, based on select user-specific positional information.

18. A computer-implemented method for managing digital content in an extensible media format, the method comprising the steps of:
implementing an at least one initial request server in memory on an at least one computing device, said initial request server configured for receiving and processing requests for content from an at least one client device in the possession of a user;
implementing an at least one content server in memory on the at least one computing device, said content server configured for storing and selectively distributing the content;
implementing an at least one key server in memory on the at least one computing device, said key server configured for creating and storing a unique key file to be associated with the user;
storing the content in an at least one text-based extensible media format (“EMF”) file, each EMF file comprising a frame page containing a frame page identifier, used for sequentially arranging the at least one EMF file when assembling the content on the client device, and an at least one frame, each frame containing at least a portion of the content along with a frame identifier used for sequentially arranging the at least one frame when assembling the content on the client device; and
upon the initial request server receiving a content request from the user via the associated client device:
obtaining from the key server the key file associated with said user;
separately encrypting at least one of the at least one EMF file containing the requested content using said key file; and
transmitting each of the at least one encrypted EMF file to said client device.

19. A computer-implemented method for managing digital content in an extensible media format, the method comprising the steps of:
implementing an at least one initial request server in memory on an at least one computing device, said initial request server configured for receiving and processing requests for content from an at least one client device in the possession of a user;
implementing an at least one content server in memory on the at least one computing device, said content server configured for storing and selectively distributing the content;
storing the content in an at least one text-based extensible media format (“EMF”) file, each EMF file comprising a frame page containing a frame page identifier, used for sequentially arranging the at least one EMF file when assembling the content on the client device, and an at least one frame, each frame containing at least a portion of the content along with a frame identifier used for sequentially arranging the at least one frame when assembling the content on the client device;
separately compressing at least one of the at least one EMF file containing the content; and
upon the initial request server receiving a content request from the user via the associated client device, transmitting to said client device each of the at least one compressed EMF file containing at least a portion of the requested content.
